(19) United States
(12) Patent Application Publication
(10) Pub. No.: US 2008/0303320 A1
(43) Pub. Date: Dec. 11, 2008

(54) ADJUSTABLE SEAT SUPPORT

(76) Inventor: Paul Steven Schranz, Vancouver (CA)

Correspondence Address: PAUL STEVEN SCHRANZ, BOX G-30 RR1, BOWEN ISLAND, BC, V0N 1G0, CA

(21) Appl. No.: 12/134,205

(22) Filed: Jun. 6, 2008

Related U.S. Application Data
(60) Provisional application No. 60/942,209, filed on Jun. 6, 2007.

(51) Int. Cl. B62K 19/36

(52) U.S. Cl. 297/215.14

(57) ABSTRACT

There is provided an adjustable seat support for a bicycle. The adjustable seat support has a front and a back orientation corresponding to the front and the back of a bicycle. The adjustable seat support includes a seat connecting mechanism for connecting a seat with the adjustable seat support. There is a means for telescoping that adjusts the seat connecting mechanism upwards and towards the front of the adjustable seat support, and downwards and towards the back of the adjustable seat support. A supporting structure supports the means for telescoping on the bicycle frame.

### CROSS-REFERENCE TO RELATED APPLICATION

This application claims priority of the previously filed U.S. Provisional Application No. 60/942,209, filed on Jun. 6, 2007.

### BACKGROUND OF THE INVENTION

1. Field of the Invention

This invention relates generally to seat supports for bicycles. More particularly, it relates to an adjustable seat support for bicycles.

2. Description of the Related Art

Conventionally, bicycles typically have an adjustable seat post for adjusting the bicycle seat to the rider's desired position. Generally, the seat post is received within the upright seat post receiving shaft of a bicycle, and is slid to the correct position and then clamped in place. It is important to achieve the correct position for the bicycle seat so that pedaling efficiency is maximized, and so that stresses on the knees and over extension of the hamstrings are minimized.

More advanced adjustable seat posts allow for a quick adjustment of the bicycle seat along the upright seat post axis by employing a locking spring mechanism that biases the bicycle seat in an upward direction, as disclosed in U.S. Pat. No. 6,478,278, issued Nov. 12, 2002 to Allen Gary Duncan, for example.

U.S. Pat. No. 5,346,235 discloses a pivoting seat system that includes articulated linkage means for operatively moving a saddle to and securing the saddle at selected positions along a path relative to the bicycle frame between a predetermined standard riding position and a relatively more rearward position.

However there is a need for an improved adjustable seat support for bicycle, which provides an adjustment for a bicycle seat upwards and towards the front of the bicycle, and downwards and towards the back of the bicycle.

### BRIEF SUMMARY OF INVENTION

In one aspect of the present invention there is an adjustable seat support for a bicycle having a front and a back orientation corresponding to the front and the back of a bicycle. The adjustable seat support comprises a seat connecting mechanism for connecting a seat with the adjustable seat support. There is a means for telescoping that adjusts the seat connecting mechanism upwards and towards the front of the adjustable seat support, and downwards and towards the back of the adjustable seat support. A supporting structure supports the means for telescoping.

In another aspect of the present invention, there is in combination a bicycle and an adjustable seat support. The adjustable seat support comprises a seat connecting mechanism for connecting a seat with the adjustable seat support. There is means for telescoping that adjusts the seat connecting mechanism upwards and towards the front of the bicycle, and downwards and towards the back of the bicycle. A supporting structure supports the means for telescoping on the bicycle.

### BRIEF DESCRIPTION OF DRAWINGS

The invention will be more readily understood from the following description of preferred embodiments thereof given, by way of example only, with reference to the accompanying drawings, in which:

FIG. 1 is a side elevational view of an adjustable seat support in an elevated position according to one embodiment of the present invention;

FIG. 2 is a side elevational view of the adjustable seat support of FIG. 1 in a lowered position;

FIG. 3 is a partial sectional view along line 3-3′ of FIG. 1;

FIGS. 4A, 4B & 4C are sectional views taken along line 4-4′ of FIG. 3;

FIG. 5 is a side elevational view of an adjustable seat support according to another embodiment of the present invention;

FIG. 6 is a side elevational view of an adjustable seat support according to another embodiment of the present invention;

FIG. 7 is a side elevational view of an adjustable seat support according to another embodiment of the present invention;

FIG. 8 is a partial sectional view taken along line 8-8′ of the adjustable seat support of FIG. 7;

FIG. 9 is a partial sectional view taken along line 8-8′ of the adjustable seat support of FIG. 7;

FIG. 10 is a partial sectional view taken along line 10-10′ of the adjustable seat support of FIG. 7;

FIG. 11 is a partial sectional view taken along line 10-10′ of the adjustable seat support of FIG. 7;

FIG. 12 is a partial sectional view taken along line 10-10′ of the adjustable seat support of FIG. 7;

FIG. 13 is a block diagram view of an actuation means of the adjustable seat support of FIG. 7;

FIG. 14 is a signal diagram of the actuation means of FIG. 13;

FIGS. 15a to 15f are partial inside-out views of a telescoping member of the adjustable seat support of FIG. 7;

FIGS. 16a to 16f are partial sectional views of respective ones of the telescoping members of FIGS. 15a to 15f;

FIG. 17 is a partial frontal view of the adjustable seat support of FIG. 7;

FIG. 18 is an exploded view of a seat clamp of the adjustable seat support of FIG. 17;

FIG. 19 is an end view of a telescoping mechanism of the adjustable seat support of FIG. 7 according another embodiment of the present invention;

FIG. 20 is a cross-sectional view of a telescoping mechanism of the adjustable seat support of FIG. 7 according to another embodiment of the present invention;

FIG. 21 is a side elevational view of an end plate of a seat clamping mechanism of the telescoping mechanism of FIG. 20;

FIG. 22 is a side elevational view of an end plate of a seat clamping mechanism of the telescoping mechanism of FIG. 20;

FIG. 23 is a side elevational view of an elongate member of the telescoping mechanism of FIG. 20;

FIG. 24 is a partial sectional view of a telescoping means taken along line 10-10′ of the adjustable seat support of FIG. 7 according to another embodiment of the present invention;

FIG. 25 is a block diagram view of an actuation means of the adjustable seat support of FIG. 24;

FIG. 26 is a signal diagram of the actuation means of FIG. 25;

FIG. 27 is a side elevational view of an adjustable seat support according to another embodiment of the present invention;

FIG. 28 is a partial sectional view taken along line 28-28′ of the adjustable seat support of FIG. 27;

FIG. 29 is a partial sectional view of taken along line 29-29′ of the adjustable seat support of FIG. 27;

FIG. 30 is a partial sectional view of taken along line 29-29′ of the adjustable seat support of FIG. 27 according to another embodiment of the present invention;

FIG. 31 is a block diagram view of an electric actuator of the adjustable seat post of FIG. 7;

FIG. 32 is a side elevational view of an adjustable seat support in an elevated position according to another embodiment of the present invention;

FIGS. 33A and 33B are cross sectional views of the adjustable seat support of FIG. 32 taken along line 2-2′;

FIG. 34 is a sectional view of a telescoping mechanism taken along line 3-3′ of FIG. 32;

FIG. 35A is a plan view of a end disc in the telescoping mechanism of FIG. 34;

FIG. 35B is a side elevational view of the end disc of FIG. 35A;

FIG. 36A is an elevational view of a support of a seat connecting mechanism of the telescoping mechanism of FIG. 34;

FIG. 36B is a bottom plan view of the support of FIG. 36A;

FIGS. 37A and 37B are plan views of circular tubes of the telescoping mechanism of FIG. 34;

FIG. 38 is a sectional view of a telescoping mechanism according to another embodiment of the present invention; and

FIG. 39 is a partial sectional view along line 3-3′ of FIG. 1 according to another embodiment of the present invention.

### DESCRIPTION OF THE PREFERRED EMBODIMENTS

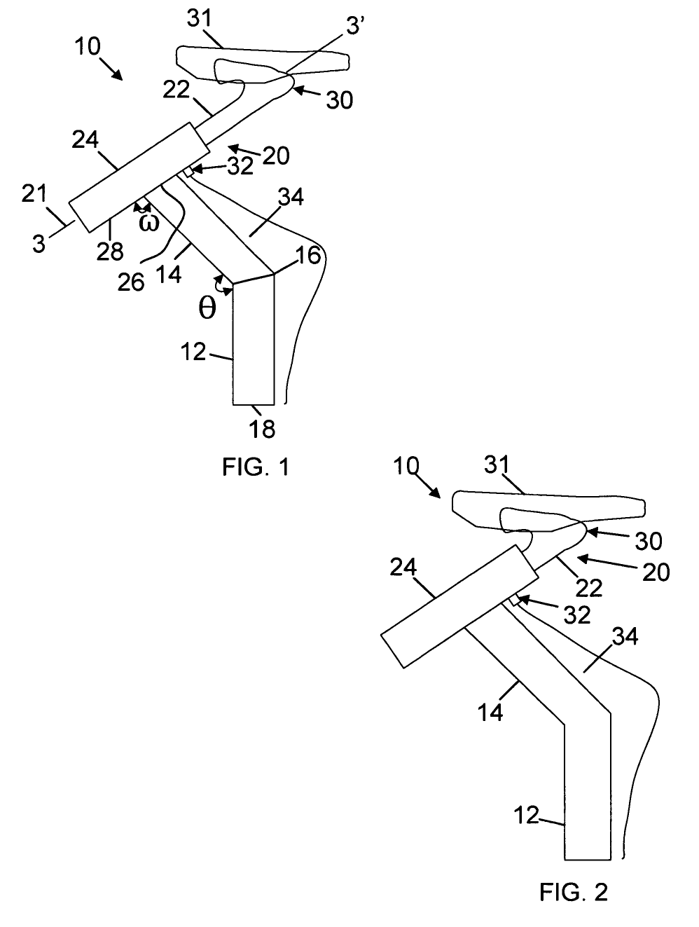

Referring to the figures and first to FIG. 1, there is an adjustable seat support indicated generally by reference numeral 10, shown in an elevated position. The adjustable seat support 10 comprises a first elongate member and a second elongate member in the form of tubes 12 and 14 respectively in this example. The tubes 12 and 14 are connected with each other at joint 16, and form an angle θ therebetween. In other examples, the tubes 12 and 14 can be a single tube having a bend instead of joint 16.

The tube 12 has an end 18 which is inserted into a seat post receiving shaft of a bicycle frame (not shown) and secured thereto by a conventional securing mechanism (not shown), for example a clamp.

The adjustable seat support 10 also includes a telescoping mechanism 20 comprising a third elongate member 22 telescopically received in a fourth elongate member 24. The telescoping mechanism 20 has a longitudinal axis 21, and is inclined from the aft of the bicycle upwards towards the front of the bicycle. The telescoping mechanism 20 is described in more detail below.

The third elongate member 22 has a seat connecting mechanism 30, which is shown illustratively in the figures. The seat connecting mechanism 30 is a conventional seat connecting mechanism in this example, and connects a conventional bicycle seat 31 with the adjustable seat support 10. The telescoping mechanism 20 adjusts the seat connecting mechanism 30 along the axis 21, in this example. It is possible that the path of travel of the seat 31 due to the telescoping mechanism 20 is along an arc in other examples.

The tube 14 has an end 26 connected with a side 28 of the fourth elongate member 24 forming an angle ω therebetween. The tubes 12 and 14 form a supporting structure for the telescoping mechanism 20.

It is understood that the angles θ and ω are selectively chosen based on the geometry of the bicycle frame, and especially the geometry of the seat post receiving shaft of the bicycle frame with which the adjustable seat support 10 is secured.

There is also a latching mechanism indicated generally by reference numeral 32 which is operatively connected with cable 34. The cable 34 is operatively connected with a lever (not shown) so that the lever can actuate the latching mechanism 32 thereby allowing the telescoping mechanism 20 to adjust, which is described in more detail below.

Referring now to FIG. 2, the adjustable seat support 10 is shown in a lowered position. The adjustable seat support 10 allows the seat 31 of the bicycle to be adjusted down and towards the back end of the bicycle, or up and towards the front end of the bicycle. The distance between the seat 31 and the bottom bracket (not shown) of the bicycle can be substantially the same when the seat 31 is in the elevated position as shown in FIG. 1, and when the seat 31 is in the lowered position as shown in FIG. 2, depending upon the angles θ and ω, which allows the pedaling efficiency to be substantially maintained therebetween. It is advantageous to choose the angles θ and ω such that pedaling efficiency is substantially maintained between the elevated and lowered positions of seat 31, however, in some situations the pedaling efficiency can be reduced advantageously when the seat is in the elevated position or when the seat is in the lowered position. For example, the needs of a road cyclist are different than the needs of a mountain bike cyclist. Similarly, the needs of a downhill mountain bike cyclist are different than the needs of a cross country mountain bike cyclist.

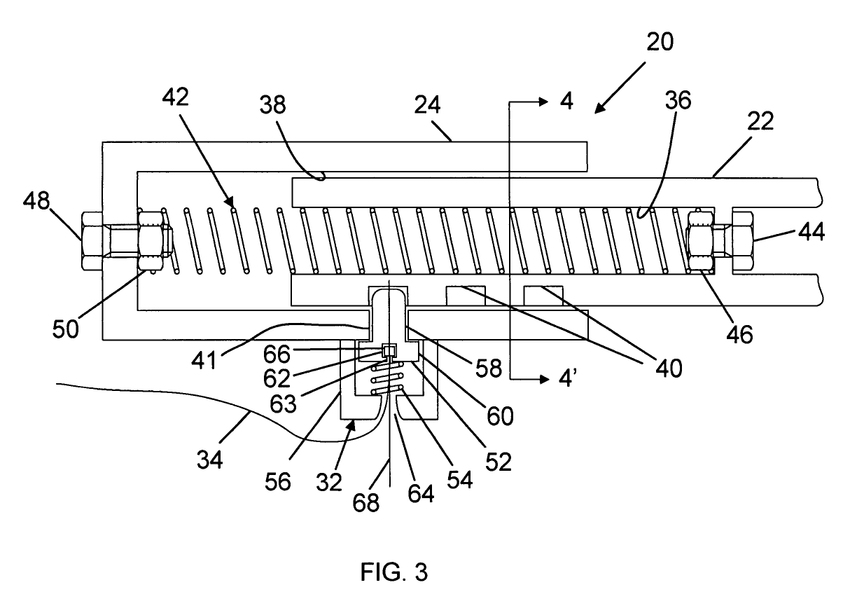

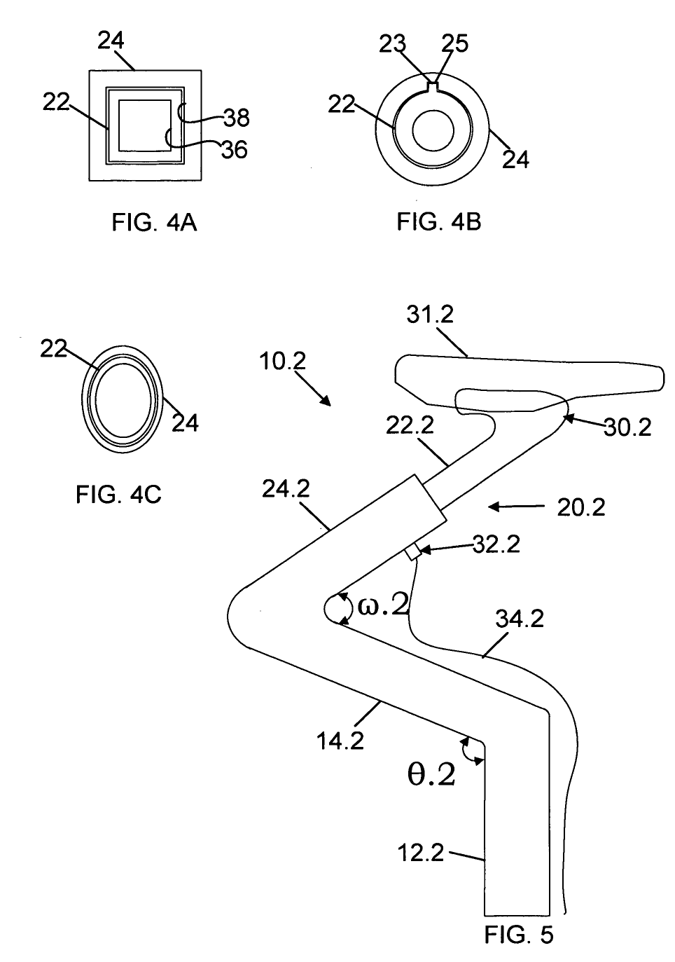

Referring now to FIGS. 3 & 4A, the telescoping mechanism 20 is shown in more detail. The third and fourth elongate members 22 and 24 are in the form of square tubes in this example, having inner surfaces 36 and 38 respectively. The fourth elongate member 24 has a bore 41. The third elongate member 22 has a plurality of bores in the form of notches 40, in which there are three in this example. It is also possible in other examples for the bores 40 to be holes in the third elongate member 22. In further examples, the third and fourth elongate members 22 and 24 can be cylindrical tubes, as shown in FIG. 4B, or egg-shaped, oval tubes, as shown in FIG. 4C. It is possible that the shapes of members 22 and 24 can be as shown in FIGS. 4A, 4B and 4C for all embodiments in the present invention.

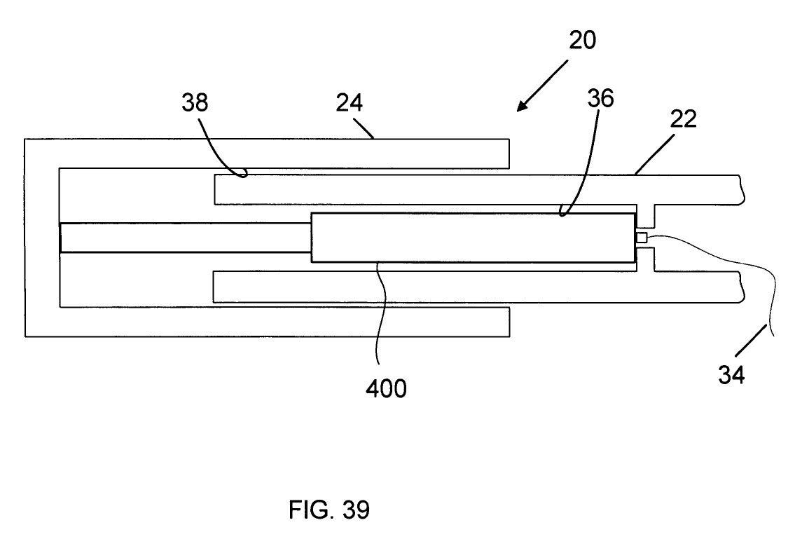

There is a helical compression spring 42 operatively connected with the third and fourth elongate members 22 and 24. Referring to FIG. 39, in other embodiments it is possible to use a gas spring 400 instead of the spring 42. Referring back to FIGS. 3 & 4A, the spring 42 is secured with the third elongate member 22 by a bolt 44 and a nut 46, and with the fourth elongate member 24 by a bolt 48 and a nut 50. The nuts 46 and 50 are connected with the spring 42 at opposite ends thereof. The spring 42 biases the third elongate member 22 to extend out of the fourth elongate member 24.

The latching mechanism 32 comprises a plunger 52, a helical compression spring 54 and a housing 56. The plunger 52 comprises a shaft 58 and a head 60. The shaft 58 extends through the bore 41. The head 60 has a bore 62 and bore 63. The housing 56 has a bore 64. The cable 34 has a ferrule 66 at one end. The cable 34 extends through the bore 64, the spring 54 and the bore 63, and the ferrule 66 is placed in the bore 62. The ferrule 66 has a larger diameter than the bore 63 and is therefore held in place in the plunger 52. The spring 54 biases the plunger 52 towards the third elongate member 22, and into one of the notches 40.

In operation, first consider the seat 31 being initially in the elevated position. The rider of the bicycle actuates the lever which pulls the cable 34 and therefore the plunger 50. The plunger 50 compresses the spring 54 as it moves along axis 68 and clears the notch 40, allowing the third elongate member 22 to telescope with respect to the fourth elongate member 24. Once the third elongate member 22 is free to telescope, the rider presses down on the seat 31 to compress the spring 42 and move the third elongate member 22 into the fourth elongate member 24, thereby moving the seat 31 downwards and towards the back of the bicycle. The rider releases the lever so that the spring 54 pushes the plunger 52 towards the third elongate member 22 such that it again engages one of the notches 40, thereby securing the third elongate member 22 in place and preventing further telescoping action.

To return the seat 31 to an elevated position, the rider once again actuates the lever in order to retract the plunger 52 from the notch 40, thereby allowing the third elongate member 22 to telescope with respect to the fourth elongate member 24. The rider raises himself off the seat 31, so that the spring 42 can push the third elongate member 22 out of the fourth elongate member 24, thereby moving the seat 31 upwards and towards the front of the bicycle. The rider releases the lever so that the spring 54 pushes the plunger 52 towards the third elongate member 22 such that it again engages one of the notches 40, thereby securing the third elongate member 22 in place and preventing further telescoping action.

Referring now to FIG. 5, there is shown another embodiment of the present invention, wherein like parts to the previous embodiment have like reference numerals with an additional suffix “0.2”. This embodiment is similar to the first embodiment, and only the differences are discussed. The tube 14.2 is shown attached to an end of the telescoping mechanism 20.2.

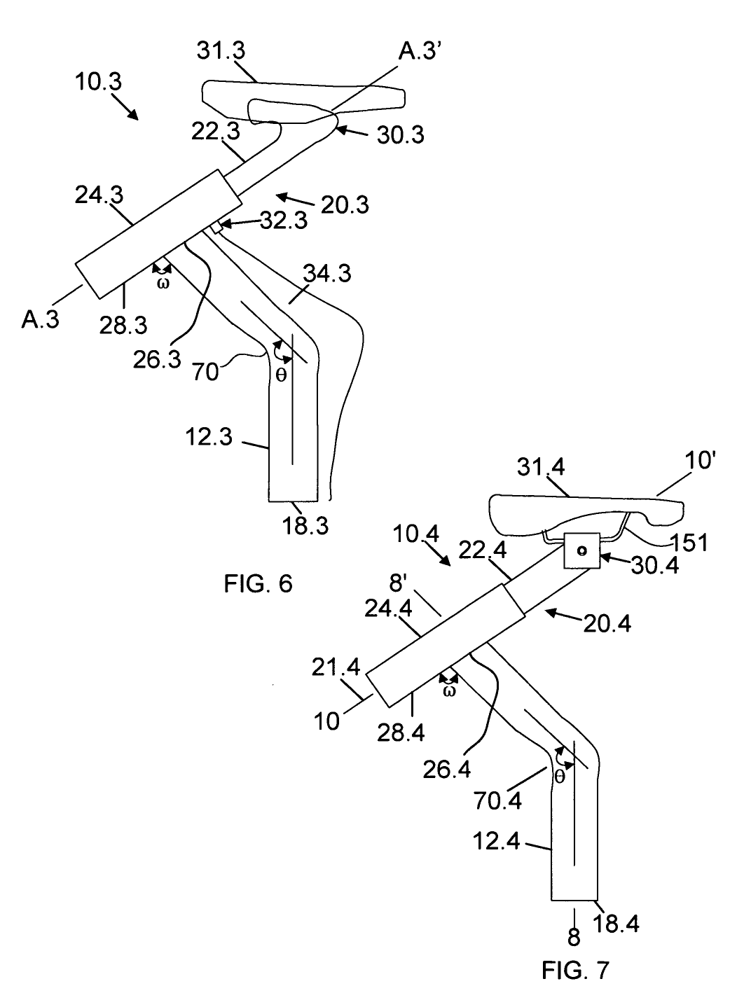

Referring now to FIG. 6, there is shown another embodiment of the present invention, wherein like parts to the previous embodiments have like reference numerals with an additional suffix “0.3”. This embodiment is similar to the first embodiment, and only the differences are discussed. There is a single tube 12.3 having a bend 70 and an end 26.3 connected with the side 28.3 of the telescoping mechanism 20.3.

Referring now to FIGS. 7 to 12, there is shown another embodiment of the present invention, wherein like parts to the previous embodiments have like reference numerals with an additional suffix “0.4”. There is an adjustable seat support 10.4 having a first elongate member 12.4. The first elongate member 12.4 has a bend 70.4 in this example. In other examples, the first elongate member 12.4 can comprise two elongate members connected at a joint where bend 70.4 exists in FIG. 7.

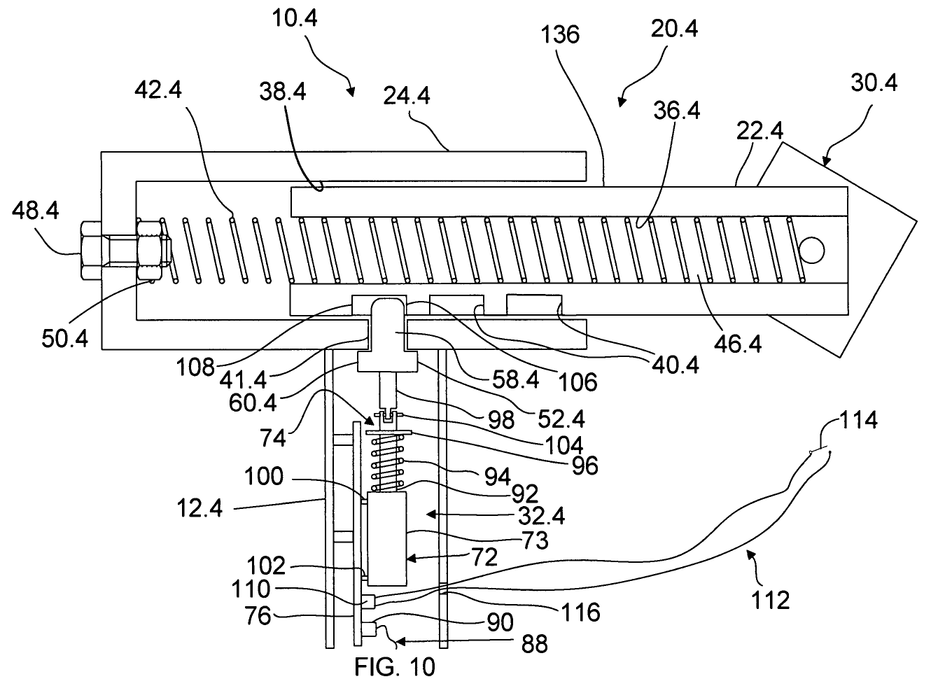

There is also a telescoping mechanism 20.4 comprising a second elongate member 22.4 and a third elongate member 24.4 in the form of tubes, which are square tubes in this example, but can be other types of tubes in other examples. The second elongate member 22.4 is telescopically received within the third elongate member 24.4. The first elongate member 12.4 connects with the third elongate member 24.4 at end 26.4. The telescoping mechanism 20.4 further includes a spring 42.4 best seen in FIG. 10, which telescopically biases the second elongate member 22.4 out of the third elongate member 24.4. There is also a seat connecting mechanism 30.4 which connects a conventional bicycle seat 31.4 with the second elongate member 22.4.

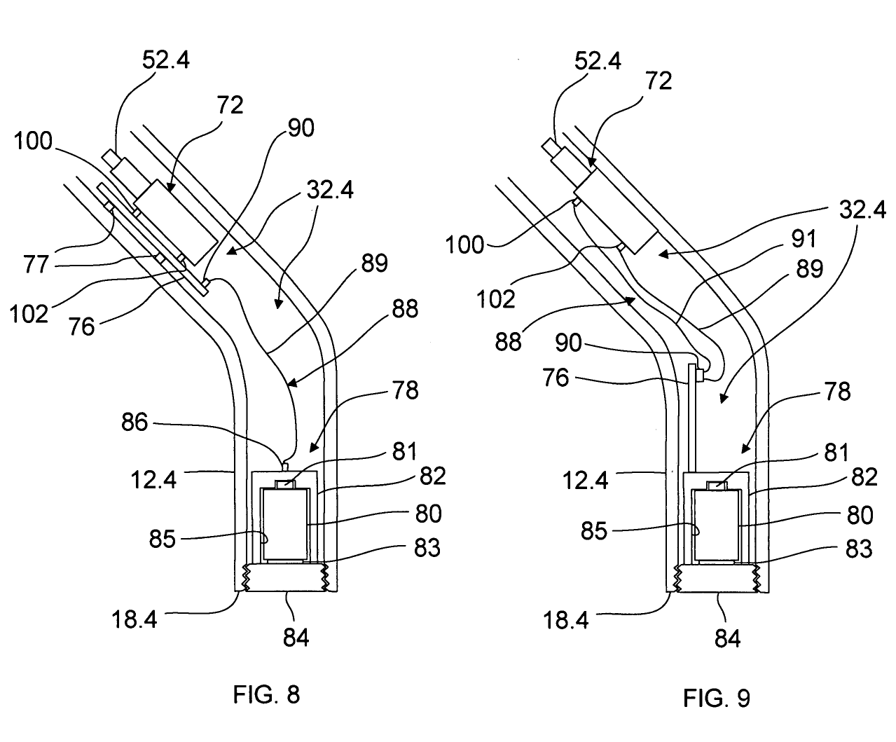

Referring to FIG. 8, there is shown a latching mechanism indicated generally by reference numeral 32.4. The latching mechanism 32.4 comprises an electromechanical actuator 72, a plunger 52.4, a printed circuit board 76 and a power source assembly indicated generally by reference numeral 78. The printed circuit board 76 is connected with the first elongate member 12.4 by standoffs 77.

The power source assembly 78 includes a battery 80, a battery holder 82 and an end cap 84. The battery has a first terminal 81 providing a positive potential, and a second terminal 83 providing a negative potential in this example. The battery holder 82 is connected with the end cap 84. The first elongate member 12.4 is a cylindrical tube, in this example, having an end 18.4. The battery holder 82 is inserted in the end 18.4 of the first elongate member 12.4 and the end cap 84 is threadedly received thereat.

The battery holder 82 has an electrical connector 86, which is electrically connected with the first terminal 81, the positive terminal in this example. A wire assembly 88 electrically connects the first terminal 81 to a connector 90 on the printed circuit board 76, thereby providing the positive potential of the battery to the printed circuit board 76. In this example, the wire assembly 88 comprises a wire 89,

The second terminal 83 of the battery is electrically connected with the end cap 84, which in turn is electrically connected with the first elongate member 12.4, which in turn is electrically connected with the printed circuit 76 by way of the standoffs 77. In this example, the end cap 84, the first elongate member 12.4 and the standoffs 77 are electrically conductive. Thus the negative potential of the battery 80 is provided to the printed circuit board 76.

In other examples, the second terminal 83 can be electrically connected to the printed circuit by way of another wire connected between connectors 86 and 90, which is electrically isolated from wire 89. This would be suitable in embodiments where the first elongate member 12.4 is not sufficiently electrical conductive for operation as an electrical path.

The battery 80 is replaced by first unscrewing the end cap 84 out of the end 18.4 of the first elongate member 12.4 and removing the battery holder 82. The battery 80 can then be removed from the battery holder 82 along an opening in the side having perimeter 85, and replaced with another battery. In a similar manner the battery holder is reinserted in the first elongate member 12.4 at the end 18.4, and the end cap 84 is threadedly engaged thereto. It is understood that the wire 88 is of sufficient length and character to permit twisting as the end cap is threaded into and out of the end 18.4. In other examples, there may be more than one battery 80 inserted into the battery holder 82 configured in series or parallel operation, and it is understood that these configurations are considered within the scope of the present invention.

In other embodiments of the present invention, the printed circuit board 76 can be connected with the battery holder 82, as illustrated in FIG. 9. The electromechanical actuator 72 is secured with the elongate member 12.4, and is electrically connected with the printed circuit board 76 by the wire assembly 88. In this embodiment the positive and negative terminals 81 and 83 of the battery 80 are electrically connected with the printed circuit board. It is also possible for the printed circuit board 76 to be connected with the end cap 84 (not shown), and the battery holder 82 connected singularly with the printed circuit board 76.

Referring now to FIG. 10, the latching mechanism 32.4 is described in more detail. The electromechanical actuator 72 is a solenoid in this example, but can be other types of electromechanical actuators in other examples, e.g. an electric motor. The solenoid includes a housing 73 and an actuating rod mechanism 74. The actuating rod mechanism 74 includes a movable solenoid core 92, a helical compression spring 94, a spring retainer 96 and, in this example, a connecting rod 98. The spring retainer 96 is affixed to the solenoid core 92, and the helical compression spring 94 biases the spring retainer and the core out of the housing 73. The solenoid 72 has a permanent magnet (not shown) in the housing 73 so that in combination with the core 92, the spring 94 and the spring retainer 96, the solenoid 72 acts as a magnetically latched type solenoid.

The solenoid 72 further includes a first wire terminal 100 and a second wire terminal 102 which are both electrically connected with the printed circuit board 76. The printed circuit board 76 has electronics which provides electrical signals to the first and second wire terminals 100 and 102 in order to control the operation of the solenoid, which will next be described in more detail.

The wire terminals 100 and 102 are driven with a first electrical polarity in order for the solenoid 72 to apply a force to the core 92 to retract the core into the solenoid housing 73. The spring retaining cap 96 compresses the spring 94 as the solenoid core 92 is retracted into the housing 73. The permanent magnet (not shown) in the housing 73 latches the core 92 as it is retracted into the housing 73. The first electrical polarity can be removed from the wire terminals 100 and 102 when the permanent magnet latches the core 92. The permanent magnet provides sufficient force to the core 92 to overcome the bias provided by the compressed spring 94, thereby retaining the core 92 within the housing 73. A portion of the core 92 remains external to the housing 73 when the core 92 is latched by the permanent magnet.

The wire terminals 100 and 102 are driven with a second electrical polarity which is opposite to that of the first electrical polarity in order to unlatch the core 92 from within the housing 73 of the solenoid 72. The second electrical polarity causes the solenoid 72 to apply a force to the core 92 which in combination with the bias of the spring 94 is sufficient to overcome the latching force of the permanent magnet, which causes the core to extend outwardly of the housing 73. The second electrical polarity can be removed from the wire terminals 100 and 102 when the core 92 has moved a sufficient distance so that the permanent magnet cannot overcome the bias of the spring 94.

The interface between the electromechanical actuator 72 and the telescoping mechanism 20.4 is now discussed. The connecting rod 98 adapts the solenoid core 92 to the plunger 52.4. A pin 104 connects the rod 98 to the core 92 and allows rotation between the rod 98 and the core 92 about the longitudinal axis of the pin 104, providing one axis of rotation. The core 92 is inherently free to rotate within the housing 73 along the longitudinal axis of the housing, and therefore there are two axes of rotation for the core 92, the rod 98 and the plunger 52.4. These two axes of rotation relax the requirements to line up the longitudinal axis of the core 92 with the bore 41.4 of the third elongate member 24.4. The plunger 52.4 can be directly connected with the core 92 in other embodiments, provided the longitudinal axis of the core is substantially aligned with the longitudinal axis of the bore 41.4 so that reciprocation of the plunger within the bore is possible.

The plunger 52.4 has a cylindrical shaft 58.4 and a head 60.4 in this example. The shaft 58.4 extends through the bore 41.4 in the third elongate member 24.4. The diameter of the bore 41.4 is wide enough to allow reciprocation of the shaft 58.4.

The second elongate member 22.4 has a plurality of oblong shaped bores 40.4 in the form of notches, in which there are three in this example, as best seen in FIGS. 10, 15a and 16a. It is also possible in other examples for the oblong shaped bores 40.4 to be holes completely through the tubular second elongate member 22.4. Each of the oblong shaped bores 40.4 has a first end wall 106 and a second end wall 108.

The length of the bores 40.4 extends along the longitudinal axis of the second elongate member 22.4, and the width of the bores 40.4 extends transversely to the length. The length and width of the bores 40.4 are larger than the diameter of the shaft 58.4 of the plunger 52.4. In this example, the length and width of bores 40.4 are also larger than the diameter of the bore 41.4, which tends to improve the ability of the shaft 58.4 to reciprocate within the bores 40.4, as will be discussed in more detail below.

The shaft 58.4 of the plunger 52.4 is received within the bore 40.4 in order to secure the second elongate member 22.4 in position relative to the third elongate member 24.4. However, the second elongate member 22.4 can telescope a small amount even when the shaft 58.4 is within the bore 40.4 since the length of the bore 40.4 is greater than the diameter of the shaft 58.4. For example, as the rider rests upon the seat 31.4 the second elongate member 22.4 is telescopically received within the third elongate member 24.4 until the shaft 58.4 engages the first end wall 106. When the rider rises off the seat 31.4 the spring 42.4 telescopically drives the second elongate member 22.4 out of the third elongate member 24.4 until the shaft 58.4 engages the second end wall 108 of the bore 40.4. The second elongate member 22.4 can telescope within the third elongate member beyond the amount mentioned above only when the plunger 52.4 is retracted so that the shaft 58.4 is clear of the bore 40.4, as described in more detail below.

The printed circuit board has a connector 110 which receives a wire assembly 112. The wire assembly 112 is connected with an electric actuator, in the form of a switch 114, at one end, and is received through a bore 116 in the member 12.4 and is connected with the connector 110 at an end opposite the one end. The switch 114 is operatively mounted on a bicycle that is configured with the adjustable seat support 10.4 so that the rider of the bicycle can conveniently actuate the switch while riding in both a seated position and while raised off the seat 31.4. The switch 114 is used to actuate the solenoid 72 to both retract and latch the core 92 and the plunger 52.4, and to release the core and the plunger to extend into the bore 40.4, as will be explained in more detail below.

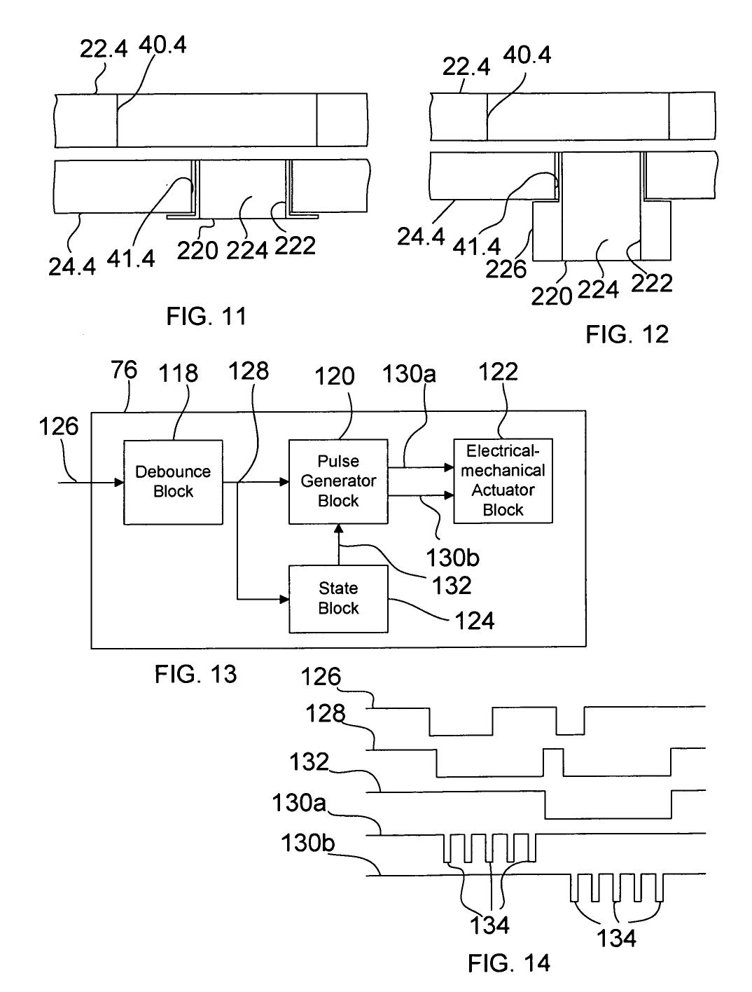

In other embodiments of the present invention, the bore 41.4 can have a sleeve 220 inserted therethrough as illustrated in FIG. 11. The sleeve 220 has a bore 222 extending therethrough, providing a pathway through the elongate member 24.4. The bore 222 has a surface 224 that is smooth and has minimal friction. The shaft 58.4 of the plunger 52.4, as seen in FIG. 10, reciprocates through the bore 222 as the adjustable seat support 10.4 is used. The smooth surface 224 of the bore 222 reduces the friction with the reciprocating shaft 58.4, thereby the reciprocating motion of the shaft 58.4 is less inhibited. This is particularly advantageous when the elongate member 24.4 is made of aluminium for example, which can have a rough surface. The sleeve serves to minimize friction between the shaft 58.4 and the bore 41.4.

In another example shown in FIG. 12, the sleeve 220 has a portion 226 extending away from the elongate member 5 24.4. The extended portion 226 acts as a guide for the shaft 58.4 and serves to further align the reciprocating motion of the shaft with the longitudinal axis of the sleeve 220. This further reduces friction between the sleeve 220 and the shaft 58.4.

Referring now to FIGS. 13 and 14, the electronics on the printed circuit board 76 is shown in more detail. The electronics includes a debounce block 118, a pulse generator block 120, an electrical actuator block 122 and a state block 124. The debounce block 118 receives a signal 126 from the switch 114 when the rider actuates the switch. The block 118 debounces the signal 126 and provides a signal 128. The debounce block 118 comprises conventional debounce circuitry, for example an RC circuit, an RC circuit combined with a monostable multivibrator or a conventional integrated circuit designed for signal debouncing.

The state block 124 receives the signal 128 and provides a signal 132 to the pulse generator block 120. The state block 124 keeps track of alternate actuations of the switch 114 so that the electromechanical actuator 72 can be activated in an alternate manner each time the switch 114 is actuated, i.e. in the present embodiment the alternate actions of the electromechanical actuator 72 are latching the core 92 within the housing 73, and unlatching the core 92 from within the housing 73. In the present embodiment, the state block 124 comprises a D-type flip-flop.

The pulse generator 120 receives the signal 128 and the signal 132 and provides signals 130a and 130b. The signal 132 indicates to the pulse generator block 120 how to drive the electromechanical actuator 72 with the signals 130a and 130b. The pulse generator block 120 comprises a conventional pulse generator, e.g. a 555 timer, a microcontroller with pulse width modulation circuitry, or a 555 timer combined with a monostable multivibrator. In some embodiments the pulse generator block 120 can include logic gates responsive to the signals 128 and 132 to generate the correct phase and timing of the signals 130a and 130b.

The electromechanical actuator block 122 comprises the electromechanical actuator 72 and driving circuitry to drive the solenoid, e.g. power metal oxide semiconductor field effect transistors (MOSFET).

It is understood that much of the above described functionality of the electronics on the printed circuit board 76 can be implemented in a microcontroller or a programmable logic device, as is understood by one skilled in the art, and those embodiments are considered to be within the scope of the present invention.

The phase and timing of the signals 130a and 130b are shown in FIG. 14 for alternate actuations of switch 114, as indicated by the signal 126. The signal 126 is a momentary signal of variable pulse width, shown in FIG. 14 to be active low, and as discussed above is debounced to produce the signal 128 of predetermined and repeatable pulse width, also shown to be active low. Either the signal 130a or 130b is generated when the signal 128 is active depending on the state of the signal 132. The signal 130a is generated when the signal 128 is active and the signal 132 is high, and the signal 130b is generated when the signal 128 is active and the signal 132 is low. The signals 130a and 130b when generated comprise a series of pulses 134 which are used to repeatedly actuate the electromechanical actuator 72, to either latch or unlatch, as will be described in more detail below.

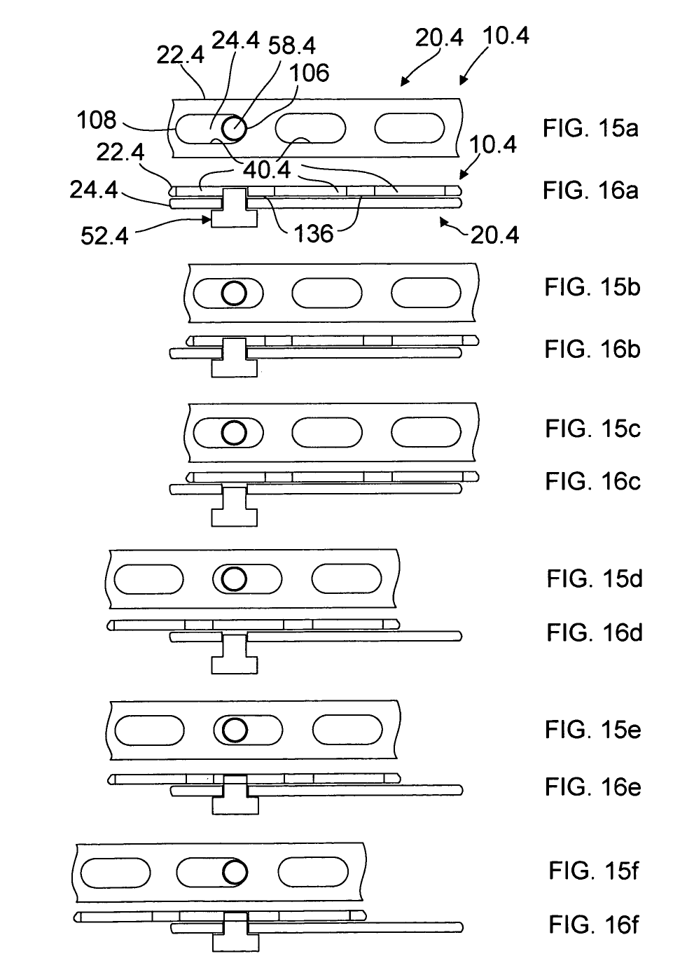

Referring now to FIGS. 15a to 15f and FIGS. 16a to 16f, the operation of the latching mechanism 32.4 is described for an adjustment cycle of the adjustable seat support 10.4. FIGS. 15a to 15f show and end view of the shaft 58.4 as seen from inside the elongate member 22.4 looking outwardly, and FIGS. 16a to 16f show a partial sectional view of the telescoping mechanism 20.4. The right hand sides of FIGS. 15a to 15f and 16a to 16f are towards the seat 31.4, shown in FIG. 7, and the left hand sides are towards an end of the telescoping mechanism 20.4 opposite the seat 31.4.

In FIGS. 15a and 16a the adjustable seat support 10.4 is shown in a secured position, as when the rider rests upon the seat 31.4. The shaft 58.4 is securing the elongate member 22.4 in position relative to the elongate member 24.4 preventing the telescoping action of the telescoping mechanism 20.4. The weight of the rider counteracts the spring bias of the spring 42.4, shown in FIG. 10, and the end 106 of the bore 40.4 downwardly abuts the shaft 58.4.

To adjust the adjustable seat support 10.4, the switch 114 is first actuated by the rider, after which the rider rises off the seat 31.4. The spring 42.4 moves the elongate member 22.4 upwards and towards the front of the bicycle, and out of the elongate member 24.4, as indicated by rightward movement of the elongate member 22.4 in FIGS. 15b and 16b. The end 106 of the bore 40.4 rises away from the shaft 58.4, which now floats in the bore 40.4.

As indicated above, the rider actuates the switch 114 first which results in the pulse stream 134 of the signal 130a being applied to the electromechanical actuator 72. The first pulse of the pulse stream 134 of the signal 130a that is applied to the electromechanical actuator 72 after the end 106 lifts off the shaft 58.4 causes the plunger 52.4 to be retracted out of the bore 40.4, as shown in FIGS. 15c and 16c. The friction between the plunger 52.4 and the end 106 of the bore 40.4, in the configuration of FIGS. 15a and 16a, is sufficient to prevent the electromechanical actuator 72 from retracting the plunger 52.4. Therefore the friction between the plunger 52.4 and the bore 40.4 is first reduced, and in this embodiment eliminated, before the plunger 52.4 is retracted.

With the elongate member 22.4 free to telescope with respect to the elongate member 24.4, the elongate member 22.4 is next adjusted downwards and towards the back of the bicycle in this example, as indicated by leftward movement in FIGS. 15d and 16d, by the rider pressing downwardly on the seat 31.4. The switch 114 is actuated again in order to actuate the electromechanical actuator 72 to return the plunger 52.4 into another one of the bores 40.4, as indicated in FIGS. 15e and 16e.

The plunger 52.4 does not need to be over one of the bores 40.4 in order to unlatch the plunger 52.4 from the solenoid 72, in which case the shaft 58.4 of the plunger will abut a surface 136 of the elongate member 22.4 when unlatched. The spring 94, best seen in FIG. 10, returns the plunger 52.4 into one of the bores 40.4, as the shaft 58.4 comes over the bore 40.4 as the elongate member 22.4 is telescoped with respect to the elongate member 24.4.

With the shaft 58.4 in the bore 40.4, the shaft 58.4 will abut the end 106 as the elongate member 22.4 is further telescoped downwardly, thereby limiting the telescoping action of the elongate members 22.4 and 24.4, as illustrated in FIGS. 15f and 16f. The elongate member 22.4 is now limited in telescoping motion with respect to the elongate member 24.4 by the ends 106 and 108.

In other examples, the solenoid 72 does not need to be the latching type. In these examples, the actuation of the solenoid 72 is directly synchronized with the actuation of the switch 114. The rider presses and holds the switch 114 in order to retract the core 92, and therefore the plunger 52.4, into the housing 73, where it is held there by the solenoid action of the solenoid 72 and not by a permanent magnet. The rider releases the switch 114 in order to stop the solenoid action of solenoid 72 and therefore return the plunger 52.4 to one of the bores 40.4 by the action of the spring 94. This example typically requires more electrical power to operate the solenoid than the previous latching example.

In still further examples, the solenoid 72 can be the bi-lateral latching type, where in a first operational mode the core 92 is driven by solenoid action to be latched by a first permanent magnet within the housing, and in a second operational mode the core 92 is driven by the opposite solenoid action substantially out of the housing where it is latched by a second permanent magnet. In both operations modes, solenoid signals are generated and applied to the solenoid for the appropriate type of solenoid action. The solenoid signals can comprise a series of pulses, or can be a continuous pulse, in which the former consumes less electrical power.

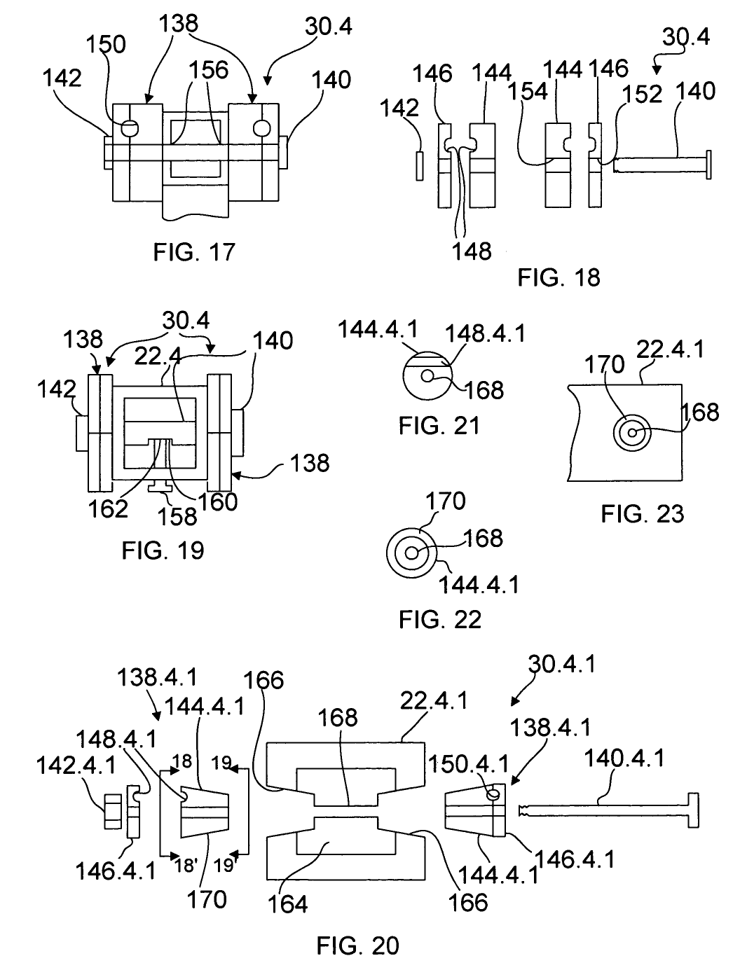

Referring now to FIGS. 17 and 18, the seat connecting mechanism 30.4 is now described in more detail. The seat connecting mechanism 30.4 comprises a pair of seat rail clamping mechanisms indicated generally by reference numeral 138, and a bolt 140 and a nut 142. Each seat rail clamping mechanism 138 comprises mutually receptive rail plates 144 and 146. Each rail plate 144 and 146 has a semi-circular rail channel 148 that aligns with the respective rail channel on the corresponding rail plate to form a circular seat rail channel 150. The seat 31.4 has a pair of rails 151, one of which is shown in FIG. 7. Each of the rails 151 is inserted into respective ones of the rail channels 150.

The rail plates 144 and 146 also include bores 152 and 154. The bolt 140 extends through the bores 152 and 154 and bores 156 in the elongate member 22.4, and threadedly engages the nut 142 thereby securing the seat 31.4 to the seat connecting mechanism 30.4. The bolt 140 also acts as a spring stop for the spring 42.4.

Referring to FIG. 19 which shows an open end view of the elongate member 22.4, in some embodiments the seat connecting mechanism 30.4 can include a bolt 158. The bolt 140 in this embodiment has a flat portion 160 at which an end 162 of bolt 158 abuts. The effect of bolt 158 is to prevent rotation of the bolt 140, thereby providing inertial and rotational stability to the seat connecting mechanism 30.4.

Referring now to FIGS. 20 to 23, there is shown a cross sectional view of a seat clamping mechanism 30.4.1, according to another embodiment of the present invention, wherein like parts to the previous embodiment have like reference numerals with an additional suffix “0.4.1”. The rail plates 144.4.1 and 146.4.1 are circular in this embodiment, and the rail plate 144.4.1 has a tapered side 170. The elongate member 22.4.1 has a solid core in the area around the seat clamping mechanism 30.4.1, e.g. a metal block 164. There is a pair of tapered bores 166 on opposite sides of and extending into the elongate member 22.4.1. A bore 168 extends through the metal block 164 between the tapered bores 166.

The rail plates 144.4.1 are inserted into respective ones of the tapered bores 166 in a press fit manner, and are rotated accordingly for the desired orientation. The rest of the assembly of the seat clamping mechanism 30.4.1 is similar to that described previously in relation to FIGS. 17 and 18. The mating of the tapered rail plate 144.4.1 with the tapered bore 166 serves to provide greater surface area between the rail clamping mechanism 138.4.1 and the elongate member 22.4.1, and therefore more friction between said two components. This provides greater rotational inertia and a more stable seat clamping mechanism 30.4.1, able to resist rotation caused by force translated from the rider through the seat 31.4 to the seat clamping mechanism.

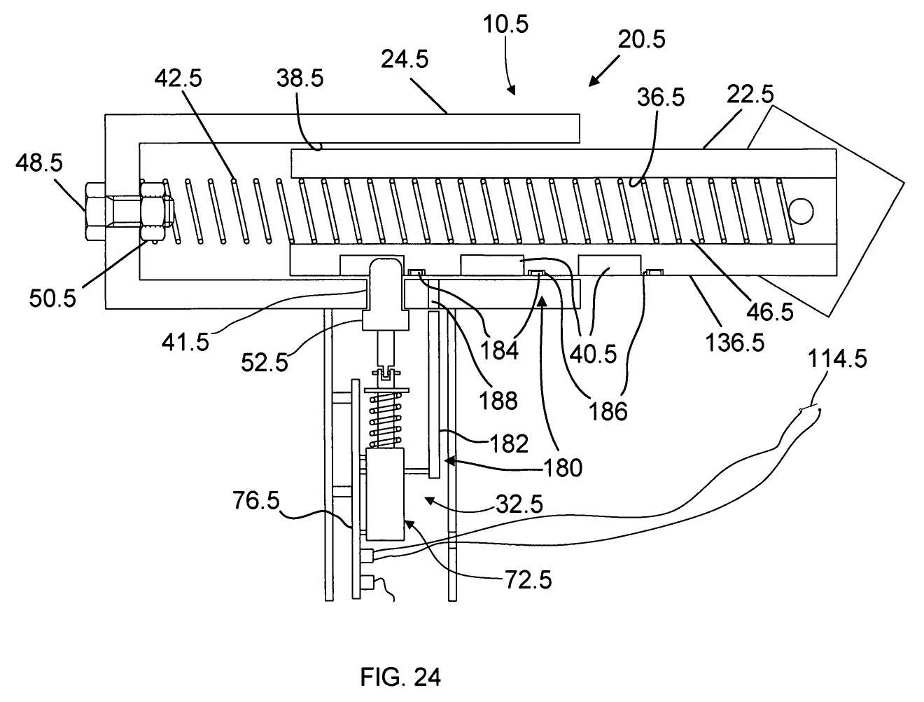

Referring now to FIG. 24, there is shown another embodiment of the present invention wherein like parts to previous embodiments have like reference numerals with an additional suffix “0.5”. This embodiment is similar to the previous embodiment and the latching mechanism 32.5 further includes a position detector indicated generally by reference numeral 180. The position detector 180 comprises a hall sensor 182, a plurality of permanent magnetic disks 184 and corresponding electronics on the printed circuit board 76.5. Each of the permanent magnetic disks 184 accompanies respective ones of the bores 40.5. The permanent magnetic disks 184 are resiliently secured to recessed bores 186 on the surface 136.5 of the elongate member 22.5. The elongate member 24.5 has a bore 188 therethrough, on one side of which the hall sensor 182 is positioned, and on the opposite side of which the permanent magnetic disks 184 pass as the elongate member 22.5 is telescoped with respect to the elongate member 24.5.

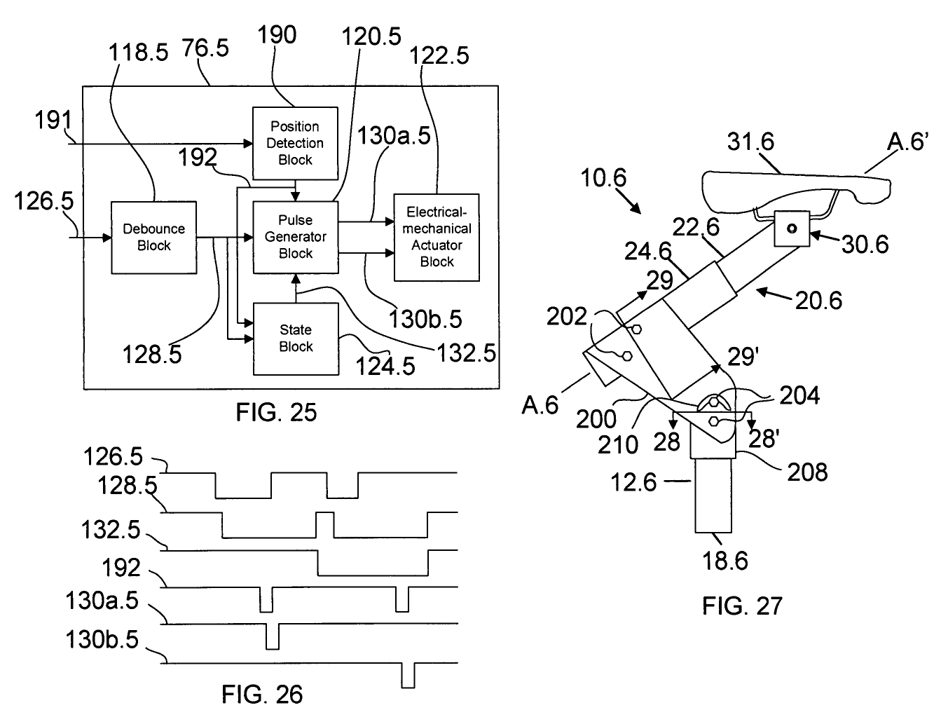

Referring now to FIGS. 25 and 26, the electronics on the circuit board 76.5 is shown in more detail. The electronics includes a position detection block 190, which comprises the hall sensor 182 and corresponding signal conditioning circuitry, e.g. operational amplifiers, and provides a signal 192. In other embodiments the hall sensor 182 may include integrated signal conditioning circuitry and output the signal 192 directly. The hall sensor 182 is responsive to the magnetic field of the permanent magnetic disks 184, represented as signal 191 which varies with the position of the magnetic disks. The pulse generator block 120.5 is responsive to the signal 192, as well as the signal 128.5 from the debounce block 118.5 and the signal 132.5 from the state block 124.5, and provides the signals 130a.5 and 130b.5 to the electrical actuator block 122.5.

The operation of the latching mechanism 32.5 of the adjustable seat post 10.5 is now discussed with reference to FIGS. 24 to 26. First, the telescoping mechanism 20.5 is in a secured configuration and the elongate member 22.5 is fixed in longitudinal position relative to the elongate member 24.5, excepting the finite amount of longitudinal movement allowed between the plunger 52.5 and the bore 40.5.

The rider actuates the switch 114.5 to activate the telescoping mechanism 20.5 to adjust, which provides the signal 126.5 to the debounce block 118.5, and in turn the signal 128.5 of predetermined pulse is generated. At this point the latching mechanism 32.5 is waiting for the signal 192 from the position detection block 190 in order to actuate the electromechanical actuator 72.5.

The rider next rises off of the seat so that the elongate member 22.5 rises with them, allowing the permanent magnetic disks 184 to pass across the bore 188, at which point the hall sensor 182 senses the first such permanent magnetic disk 184 and the position detector 180 subsequently generates the signal 192. The generation of the signal 192, in the present scenario, is indicating that the friction between the plunger 52.5 and the bore 40.5 has been reduced so that the plunger can be retracted.

The pulse generator block 120.5 then generates the signal 130a.5 in order to retract the plunger 52.5, after which the telescoping mechanism 20.5 enters the telescoping mode. The rider can now adjust the seat either upwards and towards the front of the bicycle, by letting the spring 42.5 move the elongate member 22.5 out of the elongate member 24.5, or downwards and towards the back of the bicycle, by putting downwards pressure on the seat which moves the elongate member 22.5 into the elongate member 24.5.

The signal 192 must be generated before the end of the pulse of the signal 128.5 in order for the signal 132.5, which is indicative of the position of the plunger 52.5, to toggle state. In the present example, if the signal 192 is not received it indicates that the rider did not rise off the seat within the time period equal to the predetermined pulse width of the signal 128.5, and therefore the plunger 52.5 did not change position. Note that in other embodiments the actuation of the switch 114 can put the latching mechanism 32.5 into an indefinite wait state for the signal 192. In this situation, the rider can activate the switch 114.5 to begin adjusting the adjustable seat support 10.5, but then wait for a time of their choosing to physically adjust the seat. Both approaches are equally valid, and in fact can be configurable on the same adjustable seat support 10.5.

Next, the rider actuates the switch 114.5 again to return the telescoping mechanism 20.5 to the secured configuration from the telescoping mode, after which the rider adjusts the elongate member 22.5 so that one of the permanent magnetic disks 184 passes across the bore 188 in order to generate the signal 192. The pulse generator block 120.5 is responsive to the signals 192, 132.5 and 128.5 to generate the signal 130b.5, which actuates the electromechanical actuator 72.5 to return the plunger 52.5 to one of the bores 40.5.

In this example, the signal 192 indicates that the plunger 52.5 will encounter minimal friction from the bore 40.5 as it plunges therein. Note that in the present embodiment there is in fact no friction between the bore 40.5 and the plunger 52.5 when the plunger is returned to this bore.

Again, the signal 192 must be received by the state block 124.5 before the end of the pulse of the signal 128.5 in order for the state signal 132.5 to toggle state. This guarantees that the adjustable seat post 10.5 remains in the telescoping mode until the plunger 52.5 returns to one of the bores 40.5. In other embodiments, as stated above, the activation of the switch 114.5 in the telescoping mode can put the latching mechanism 32.5 into an indefinite wait state for the signal 192.

In other examples of the present embodiment, the rider can encode the signal 126.5 by repeatably actuating the switch 114.5 the appropriate number of times to indicate by how many of the bore 40.5 positions they wish to adjust the seat. For example, if the rider wishes to adjust the seat by two of the bore 40.5 position upwards, they would actuate the switch 114.5 repeatably twice. In this situation after the telescoping mechanism 20.5 enters the telescoping mode, i.e. the plunger 52.5 is retracted towards the solenoid 72.5, the plunger 52.5 would be automatically extended away from the solenoid 72.5 after two pulses of the signal 192. The debounce block 118.5 recognize the encoded signal 126.5 and generates the required pulses for the above mentioned sequence.

If the rider wishes to adjust the seat by two of the bore 40.5 positions downwards, they would actuate the switch 114.5 repeatably twice again, but on the second actuation they would hold the switch down for an extended period of time, e.g. one second. The debounce block 118.5 would recognize the extended pulse duration of the signal 126.5 and realize the rider wishes to adjust the seat downwards. In this situation after the telescoping mechanism 20.5 enters the telescoping mode, i.e. the plunger 52.5 is retracted towards the solenoid 72.5, the plunger 52.5 would be automatically extended away from the solenoid 72.5 after three pulses of the signal 192, since one those pulses corresponds to the permanent magnetic disk 184 of the original bore 40.5, which it is passing back over during the downward telescoping movement of the member 22.5. Note that encoding the signal 126.5 can occur for a wired connection between the switch 114.5 and the debounce block 118.5, or a wireless connection between the switch 114.5 and the debounce block 118.5.

Referring now to FIGS. 27 to 30, and first to FIG. 27, there is shown another embodiment of the present invention wherein like parts to previous embodiments have like reference numerals with an additional suffix “0.6”. This embodiment is similar to previous embodiments and only the differences are discussed. The adjustable seat post 10.6 includes a pair of plates 200, only one of which is shown in FIG. 27, which connects the telescoping mechanism 20.6 with the tube 12.6.

The plates 200 are connected with opposite sides of the elongate member 24.6 by bolts 202, only two of which are shown on one side of the elongate member 24.6, with another two bolts 202 on the opposite side of the member 24.6. The bolts 202 are threadedly received by the plates 200 and the elongate member 24.6 and extend only to the inner surface 38.6, as best seen in FIG. 29. In other embodiments, when metal components are used, the plates 200 can be welded to the elongate member 24.6.

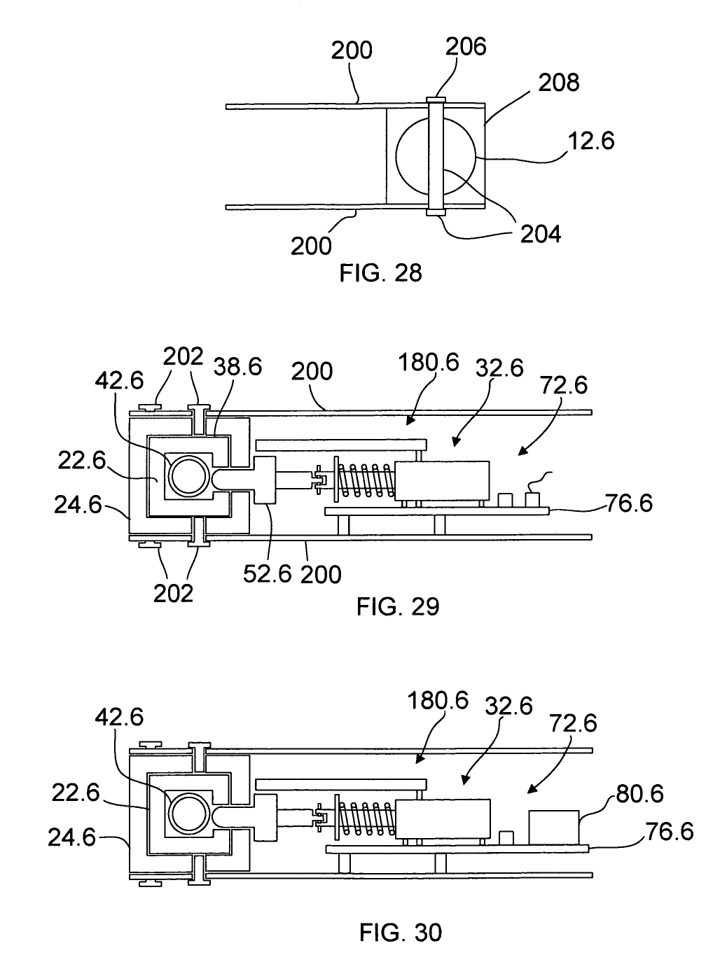

Similarly, the plates 200 are connected with the tube 12.6 by bolts 204 and nuts 206, as best seen in FIGS. 27 and 28. There is also an adapter 208, which is in the shape of a rectangular box with a cylindrical bore therethrough. The adapter 208 receives the tube 12.6 in the cylindrical bore. The plates 200 straddle the adapter 208 on opposite sides. The bolts 204 extend through the adapter 208 and the tube 12.6 and fasten to the nuts 206. In other embodiments, it is possible to connect the plates 200 directly to the tube 12.6, leaving out the adapter 208.

There is a channel 210, seen in FIG. 27, in each of the plates 200. The channels 210 allow the plates 200 to rotate about the lower bolt 204 and the nut 206 when both of the bolts 204 are loosened, allowing the pitch of the telescoping mechanism 20.6 to be adjusted accordingly. This is advantageous since different riding environments require different pitches of the telescoping mechanism 20.6, for example road cycling versus mountain biking. Furthermore, the pitch angle of bicycle seat post tubes varies from bicycle to bicycle, requiring adjustment of the pitch of the telescoping mechanism 20.5. In other embodiments, the channel 210 can be replaced by a plurality of bores spaced apart along the path of the channel 210. In other embodiments, it is possible to weld the plates 200 directly to the adapter 208, or the tube 12.6, thereby fixing the pitch of the telescoping mechanism 20.6.

FIG. 30 shows a partial sectional view of the adjustable seat support 10.6 and illustrates the latching mechanism 32.6. FIG. 30 is similar to FIG. 29, but includes the battery 80.6 directly on the printed circuit board 76.6.

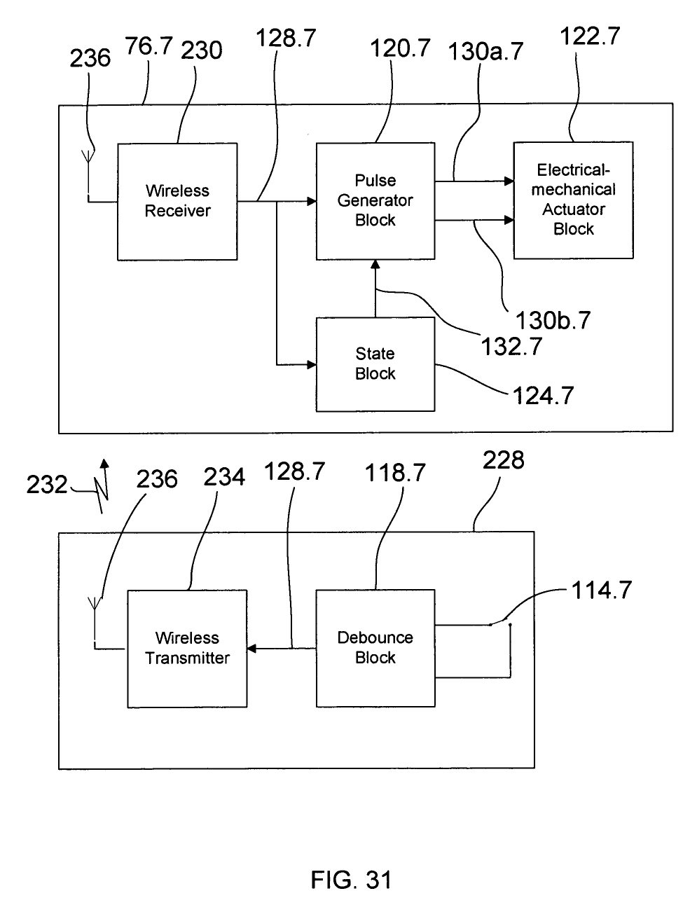

Referring now to FIG. 31, there is shown another embodiment of the present invention where like parts to previous embodiments have like reference numerals with an additional suffix “0.7”. This embodiment is similar to the embodiment of FIGS. 7, 10 and 13, except a wireless link has replaced the wire assembly 112.

A printed circuit board 228 includes an electric actuator, in the form of the switch 114.7, the debounce block 118.7 and a wireless transmitter 234. The switch 114.7 is actuated by the rider to adjust the adjustable seat support 10.4, and therefore the printed circuit board 228 is located conveniently around the handle bars of the bicycle. The printed circuit board 76.7 has a wireless receiver 230. A wireless link 236 exists between the wireless transmitter 234 and the wireless receiver 230.

The wireless transmitter 234 sends a signal 232 over the wireless link 236 when the rider actuates the switch 114.7. The wireless receiver 230 receives the signal 232 and provides the signal 128.7, and the remaining operation has been discussed in detail above. It is understood that the wireless link of FIG. 31 equally applies to all previous embodiments discussed above that use an electromechanical actuator as part of the latching mechanism.

In other examples, the wireless link 236 may be bidirectional, and the wireless receiver and transmitter 230 and 234 respectively are then wireless transceivers. This would allow information about the status of the adjustable seat support 10.4, e.g. battery status, to be delivered to the printed circuit board 228 where it may be visually displayed with light emitting diodes (LEDs). As an example only, the wireless link 236 may be Zigbee, Bluetooth, RFID or other conventional wireless technologies.

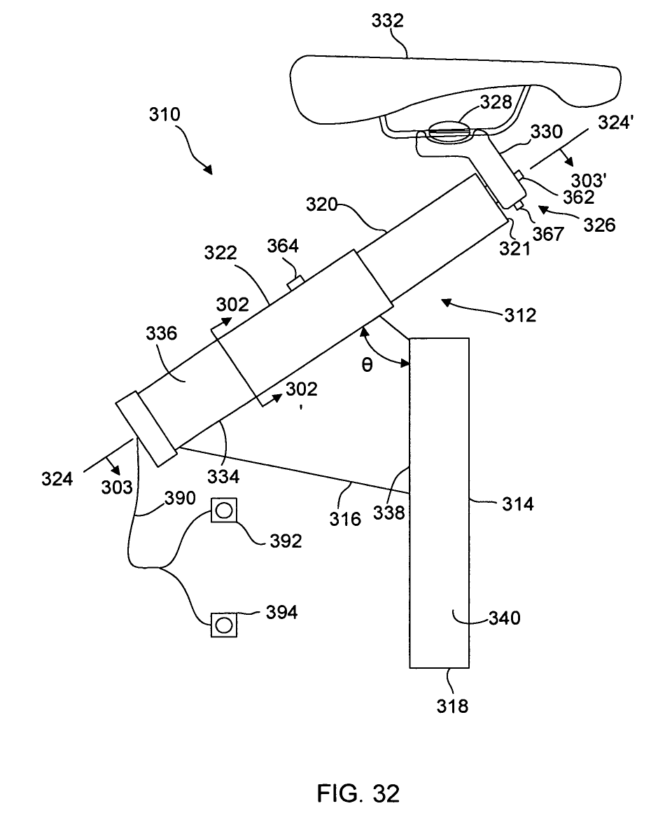

Referring now to FIG. 32, there is an adjustable seat support indicated generally by reference numeral 310, shown in an elevated position. The adjustable seat support 310 comprises a telescoping mechanism indicated generally by reference numeral 312, a first elongate member in the form of a tube 314, and a support 316. The support 316 connects the tube 314 with the telescoping mechanism 312.

The tube 314 has an outer surface 340 and an end 318. The end 318 is inserted into a seat post receiving shaft of a bicycle frame (not shown) and secured thereto by a conventional securing mechanism (not shown), for example a clamp.

The telescoping mechanism 312 comprises a second elongate member 320 telescopically received in a third elongate member 322. The third elongate member has an outer surface 336. As seen in FIG. 333A, the second and third elongate members 320 and 322 are circular tubes in this example, however in other examples they can be different shapes. The telescoping mechanism 312 has a longitudinal axis 324, and is inclined from the aft of the bicycle upwards towards the front of the bicycle. The telescoping mechanism 312 is described in more detail below.

The support 316 is in the form of a plate in this example, but can be other forms, e.g. a latticework. The plate 316 has a side 334 connected with the tube 322 at the surface 336, e.g. by a weld, and a side 338 connected with the tube 314 at the surface 340. Sides 334 and 338 form angle θ which determines the relative distance between the seat 332 and a bottom bracket of the bicycle (not shown) as the telescoping mechanism 312 adjusts the seat 332 in parallel motion to the axis 324.

It is understood that the angle θ is selectively chosen based on the geometry of the bicycle frame, and especially the geometry of the seat post receiving shaft of the bicycle frame with which the adjustable seat support 310 is secured.

The second elongate member 320 has an end 321 connected with a seat connecting mechanism indicated generally by reference numeral 326. The seat connecting mechanism 326 comprises a conventional seat connecting clamp 328 and a support 330 in this example, and connects a conventional bicycle seat 332 with the adjustable seat support 310. The telescoping mechanism 312 adjusts the seat connecting mechanism 326 along the axis 324.

The adjustable seat support 310 has actuators in the form of switches 392 & 394, which are electrically connected to the telescoping mechanism 312 by connection 390. Each of the switches 392 & 394 are mounted on respective sides of handle bars (not shown) of the bicycle. The operation of the switches 392 & 394 is described in more detail below.

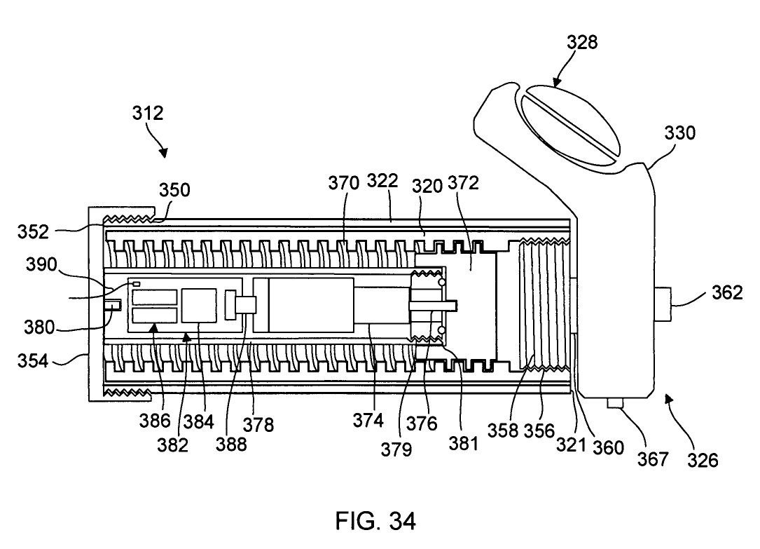

Referring now to FIG. 34 the telescoping mechanism 312 is described in more detail. The tube 322 has outer threads 350 next to end 352. An interiorly threaded end cap 354 is threaded onto the end 352 and secured thereto. In some examples a set screw can be used to secure the end cap 354 to the tube 322. The tube 320 has inner threads 356 next to the end 321. An end disc 358 is threaded into the tube 320 at the end 321 and secured thereto.

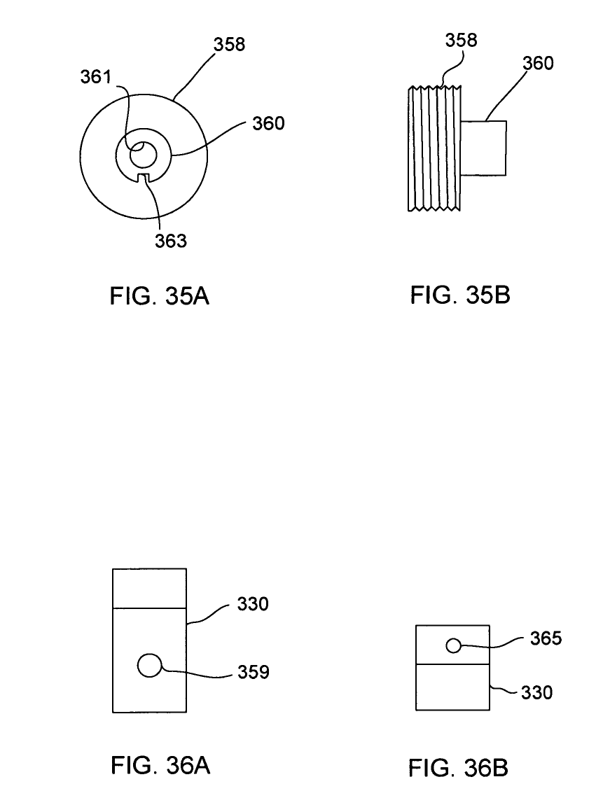

The disc 358 has a projection 360, best seen in FIGS. 35A and 35B, and the projection has a threaded bore 361. The support 330 has a bore 359, best seen in FIG. 36A, that receives the projection 360 in a press-fit manner. A bolt 362 is threaded with the bore 361 of the projection 360 to secure the support 330 and the seat connecting mechanism 326 thereto.

Referring to FIGS. 34, 35A and 36B, the projection 360 has a slot 363 in this example, and the support 330 has a threaded bore 365. A bolt 367 is threaded into the bore 365 and is recessed into the slot 363 thereby preventing rotational movement of the support 330 with respect to the projection 360.

The tube 320 has inner threads 370. A threaded spindle 372 is threadedly engaged with the threads 370. A motor 374 is connected with the spindle 372 by shaft 376. The motor 374 is secured to a support frame which in this example is tube 378. The tube 378 is secured to the tube 322 at one end by a fastening mechanism 380 and the end cap 354.

The tube 378 has interior threads 379 next to end 381. A threaded disc 383 is threadedly received by the tube 378 at the end 381. The disc 383 has ball bearings 385 at the end 381. The spindle 372 is supported by the ball bearings 385 which allow the spindle to rotate at the end 81.

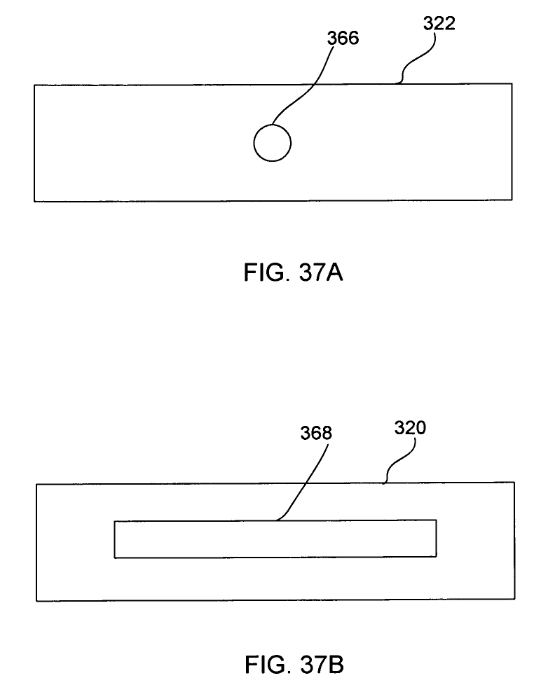

Referring to FIGS. 32, 37A and 37B, the tube 320 has a slot 368 and the tube 322 has a bore 366. A bolt 364 is threaded through the bore 366 in the tube 322, and projects into the slot 368 in the tube 320. The tube 320 is permitted to telescope with respect to the tube 322 according to the movement of the bolt 364 in the slot 368. The bolt 364 also limits the movement of the tube 320 to linear motion with respect to the tube 322, and prevents relative rotational movement between the tubes.

A control module indicated generally by reference numeral 382 controls the motor 374. The control module 382 is fastened with the tube 378. The control module 382 includes a microcontroller 384, batteries 386, electrical connection 388 and the electrical connection 390. The electrical connection 388 electrically connects the control module 382 to the motor 374. The electrical connection 390 electrically connects the control module to the switches 392 and 394.

The operation of the adjustable seat support 310 is now described. The cyclist actuates the switch 392 in order to adjust the seat 332 upwards and towards the front of the bicycle. When the switch 392 is actuated the motor 374 actuates the shaft 376 to spin the spindle 372 in one direction. The tube 320 extends out of the tube 322 due to the threaded engagement of the spindle 372 with the threads 370, thereby adjusting the seat 332 upwards and towards the front of the bicycle.

The cyclist actuates the switch 394 in order to adjust the seat 332 downwards and towards the back of the bicycle. When the switch 394 is activated the motor 374 actuates the shaft 376 in an opposite direction. The tube 320 contracts into the tube 322 due to the threaded engagement of the spindle 372 with the threads 370, thereby adjusting the seat 332 downwards and towards the back of the bicycle.

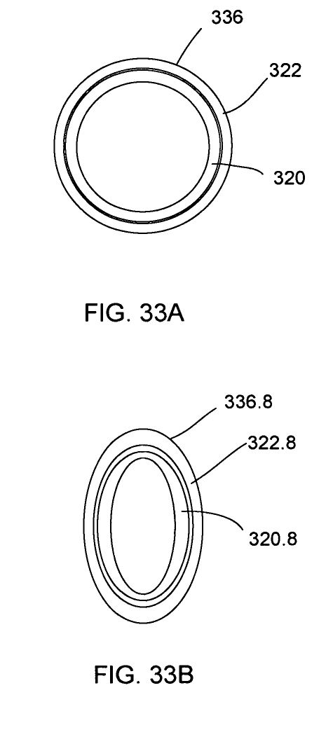

Another embodiment of the present invention is illustrated in FIG. 33B, wherein like parts have like reference numerals with an additional suffix “0.8”. The tubes 320.8 and 322.8 are elliptical in shape. This has the advantage of preventing relative rotational movement between the tubes 320.8 and 322.8 as the spindle telescopically adjusts the tube 320.8 with respect to the tube 322.8.

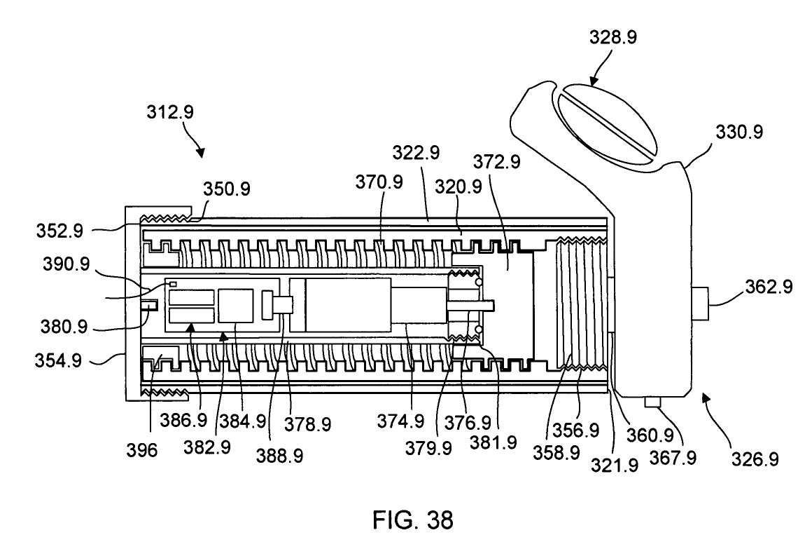

Another embodiment of the present invention is illustrated in FIG. 38, wherein like parts have like reference numerals with an additional suffix “0.9”. The telescoping mechanism 312.9 includes a cylindrical bushing 96 threadedly engaged with the tube 320.9, which supports the tube 320.9 in relation to the tube 378.9. The bushing 396 moves along with the tube 320.9 as it extends and contracts with respect to the tube 322.98.

While preferred embodiments of the present invention have been described, it is to be understood that the embodiments described are illustrative only and the scope of the invention is to be defined solely by the appended claims when accorded a full range of equivalence, many variations and modifications naturally occurring to those of skill in the art from a perusal hereof. As is readily apparent the system and method of the present invention is advantageous in several aspects.

What is claimed is:

1. An adjustable seat support for a bicycle having a front and a back orientation corresponding to the front and the back of a bicycle, the adjustable seat support comprising:
a seat connecting mechanism for connecting a seat with the adjustable seat support;
means for telescoping adjusting the seat connecting mechanism upwards and towards the front of the adjustable seat support, and downwards and towards the back of the adjustable seat support; and
a supporting structure for the means for telescoping.

2. In combination, a bicycle and an adjustable seat support, the adjustable seat support comprising:
a seat connecting mechanism for connecting a seat with the adjustable seat support;
means for telescoping adjusting the seat connecting mechanism upwards and towards the front of the bicycle, and downwards and towards the back of the bicycle; and
a supporting structure supporting the means for telescoping on the bicycle.
